(19) United States
(12) Patent Application Publication
(10) Pub. No.: US 2011/0028377 A1
(43) Pub. Date: Feb. 3, 2011

(54) Color-Protecting Detergent or Cleanser

(76) Inventors: Birgit Glüsen, Dusseldorf (DE); Thomas Eiting, Dusseldorf (DE); André Hätzelt, Dusseldorf (DE); Matthias Sunder, Dusseldorf (DE)

Correspondence Address: Henkel Corporation, 10 Finderne Avenue, Suite B, Bridgewater, NJ, 08807, US

(21) Appl. No.: 12/900,551

(22) Filed: Oct. 8, 2010

Related U.S. Application Data
(63) Continuation of application No. PCT/EP2009/054088, filed on Apr. 6, 2009.

(30) Foreign Application Priority Data
Apr. 10, 2008 (DE) 10 2008 018 503.5

(51) Int. Cl. C11D 3/37

(52) U.S. Cl. 510/360; 510/276

(57) ABSTRACT

Color protection of detergents and cleansers when used for washing or cleaning colored textile fabrics. This is accomplished by use of particulate polymers in the detergent or cleanser.

### CROSS REFERENCE TO RELATED APPLICATIONS

The present application is a continuation of International Application No. PCT/EP2009/054088 filed 6 Apr. 2009, which claims priority to German Patent Application No. 10 2008 018 503.5 filed 10 Apr. 2008, both of which are incorporated herein by reference.

The present invention relates to use of particulate water-insoluble polymers as color-transfer-inhibiting active ingredients for washing and/or cleaning of textiles, as well as washing or cleaning agents containing such compounds.

In addition to common ingredients for the washing or cleaning process such as surfactants and builder materials, washing and cleaning agents generally contain other ingredients. These can be grouped together under the term washing auxiliary substances and includes various groups of active ingredients such as foam regulators, graying inhibitors, bleaching agents, bleach activators and enzymes. Such auxiliary substances also include substances designed to prevent dyed textile fabrics from giving a different color impression after being washed. This change in color impression in washed (i.e., clean) textiles can be caused by dye components being removed from the textile by the washing or cleaning process (“fading”) and/or dyes released from textiles of a different color being deposited on the textile (“discoloration”). The discoloration aspect can also affect undyed laundry items if they are washed alongside colored laundry items.

To prevent these undesired side-effects of soil removal from textiles by treatment with conventional surfactant-containing aqueous systems, washing agents, particularly those intended as so-called color washing agents for washing colored textiles, contain active ingredients designed to stop the release of dyes from the textile or at least prevent released dyes present in the washing liquor from being deposited on textiles. However, many of the (generally water-soluble) polymers that are typically used have such a high affinity to dyes that they absorb them to an increased extent from the dyed fibers, and thus their use leads to color losses. Furthermore, many conventional color-transfer inhibitors are effective only with certain classes of dyes and cannot prevent the transfer of other dye classes.

Surprisingly it has now been found that particulate water-insoluble polymers lead to unexpectedly high color-transfer inhibition when they are used in washing agents. The prevention of the staining of white textiles or differently-colored textiles by dyes washed out of textiles is particularly pronounced. It is conceivable that because of their large surface area the polymer particles absorb dye molecules released from the dyed fabrics and prevent the dyes from being deposited on white or differently-colored textiles.

The invention utilizes particulate water-insoluble polymers to prevent the transfer of textile dyes from dyed textiles to undyed or differently-colored textiles when washed together, particularly in surfactant-containing aqueous solutions. Suitable polymers are in particular polyamide, polyester, polyimide, aramide, polyacrylonitrile, polyurethane, polypropylene, polyvinyl chloride, cellulose and copolymers of at least two of the monomers forming these polymers. Polyamide, polyurethane and cellulose are particularly preferred. The combined use of particulate polymers each corresponding to one of the cited classes is also possible.

The polymer particles preferably have particle sizes in a range of from 1 nm to 500 μm, particularly 5 nm to 100 μm. Their average particle size is preferably in a range of from 5 nm to 100 μm, particularly 1 μm to 50 μm. The particles can be round or irregular in shape. The shapes of the particles can differ from the spherical shape in such a way that their diameter in their longest spatial dimension is clearly larger, optionally by several orders of magnitude, than that in their shortest spatial dimension and particularly preferably than those in both other spatial dimensions. In this last embodiment the particles are conventionally referred to as fibers.

The particulate polymers can be added separately to the washing solution as part of a manual or machine washing or cleaning method. They are preferably brought into contact with the textile as part of a pretreatment agent in a step prior to the actual washing process, or are further preferably introduced into the washing solution as part of a washing or cleaning agent. The particulate polymers also develop their positive effect if they are used in a rinse cycle in which fabric softening active ingredients are conventionally used. Their use in a prewash step is also possible, wherein the particulate polymer then preferably remains on the textile that is subsequently to be washed or is introduced along with it into the washing liquor. The invention therefore also provides a color-protecting washing, prewashing, postwashing or cleaning agent containing a color-transfer inhibitor in the form of a particulate polymer together with conventional ingredients that are compatible with this constituent.

An agent according to the invention preferably contains 0.05 wt. % to 20 wt. %, in particular 0.1 wt. % to 5 wt. %, of the particulate polymer based on total weight of the agent.

The active ingredients concerned make a contribution to both aforementioned aspects of color consistency; in other words they prevent both discoloration and fading, although the staining prevention effect, particularly when washing white textiles, is the most marked. The invention therefore also provides the use of a particulate polymer to prevent a change in the color impression of textiles when washed, particularly in surfactant-containing aqueous solutions. A change in color impression is in no way intended to mean the difference between the soiled and the clean textile but rather a difference in color in the clean textile before and after washing.

The invention also provides a method for washing dyed textiles in surfactant-containing aqueous solutions, wherein a surfactant-containing aqueous solution that contains a particulate polymer is used. With this method it is possible also to wash white or undyed textiles together with the dyed textile without the white or undyed textile becoming stained.

In addition to the cited color-transfer-inhibiting active ingredient, an agent according to the invention can if desired also additionally contain a known color-transfer inhibitor, preferably in amounts of 0.01 wt. % to 5 wt. %, particularly 0.1 wt. % to 1 wt. %, which in a preferred embodiment of the invention is a polymer of vinyl pyrrolidone, vinyl imidazole, vinyl pyridine-N-oxide or a copolymer thereof. Polyvinyl pyrrolidones having molecular weights of 15,000 to 50,000 and those having molecular weights of over 1,000,000, particularly from 1,500,000 to 4,000,000, N-vinyl imidazole/N-vinyl pyrrolidone copolymers, polyvinyl oxazolidones, polyamine-N-oxide polymers, polyvinyl alcohols and copolymers based on acrylamidoalkenylsulfonic acids can be used. However, enzymatic systems comprising a peroxidase and hydrogen peroxide or a substance that yields hydrogen peroxide in water can also be used. The addition of a mediator compound for the peroxidase, for example, an acetosyringone, a phenol derivative, or a phenothiazine or phenoxazine, is preferred in this case, wherein aforementioned conventional polymeric color-transfer inhibitor active ingredients can additionally be used. Polyvinyl pyrrolidone for use in agents according to the invention preferably has an average molar mass in the range from 10,000 to 60,000, particularly from 25,000 to 50,000. Of the copolymers, those consisting of vinyl pyrrolidone and vinyl imidazole in a molar ratio of 5:1 to 1:1 and having an average molar mass in the range from 5000 to 50,000, particularly 10,000 to 20,000, are preferred.

Washing agents according to the invention can be solid or liquid, and can in particular be in the form of powdered solids, in consolidated particle form, as homogeneous solutions or suspensions. These agents can contain in addition to the active ingredient used according to the invention all known ingredients conventionally used in such agents. These include builder substances, surface-active surfactants, bleaching agents based on organic and/or inorganic peroxygen compounds, bleach activators, water-miscible organic solvents, enzymes, sequestering agents, electrolytes, pH regulators and further auxiliary substances such as optical brighteners, graying inhibitors, foam regulators, dyes and fragrances. It is also possible according to the invention to apply the particulate polymer to a water-insoluble cloth or to introduce it into a pouch made from a water-insoluble but water-permeable material, optionally with other conventional ingredients, and to use it in this form as an additive in the washing process. As an alternative to the last-mentioned embodiment, the particulate polymer or an agent containing it can be introduced into the washing process in portions packed in a water-soluble material such as a polyvinyl alcohol film.

Agents according to the invention can contain one or more surfactants, with anionic surfactants, non-ionic surfactants and mixtures thereof as well as cationic, zwitterionic and amphoteric surfactants being suitable.

Suitable non-ionic surfactants include alkyl glycosides and ethoxylation and/or propoxylation products of alkyl glycosides or linear or branched alcohols each having 12 to 18 C atoms in the alkyl part and 3 to 20, preferably 4 to 10, alkyl ether groups. Corresponding ethoxylation and propoxylation products of N-alkylamines, vicinal diols, fatty acid esters and fatty acid amides, which in terms of the alkyl part correspond to the cited long-chain alcohol derivatives, and of alkyl phenols having 5 to 12 C atoms in the alkyl residue can also be used.

Alkoxylated, advantageously ethoxylated, particularly primary alcohols having preferably 8 to 18 C atoms and on average 1 to 12 mol of ethylene oxide (EO) per mol of alcohol are preferably used as non-ionic surfactants. The alcohol residue can be linear or preferably methyl-branched in the 2-position, or can contain linear and methyl-branched residues in the mixture such as are conventionally present in oxoalcohol residues. However, alcohol ethoxylates containing linear residues obtained from alcohols of native origin having 12 to 18 C atoms (e.g., from coconut, palm, tallow or oleyl alcohol) and on average 2 to 8 EO per mol of alcohol are particularly preferred. The preferred ethoxylated alcohols include, for example, C₁₂-C₁₄ alcohols having 3 EO or 4 EO, C₉-C₁₁ alcohols having 7 EO, C₁₃-C₁₅ alcohols having 3 EO, 5 EO, 7 EO, or 8 EO, C₁₂-C₁₅ alcohols having 3 EO, 5 EO or 7 EO and mixtures thereof, such as mixtures of C₁₂-C₁₄ alcohol having 3 EO and C₁₂-C₁₈ alcohol having 7 EO. The specified degrees of ethoxylation are statistical averages which for an individual product can be a whole number or a fraction. Preferred alcohol ethoxylates have a narrow homolog distribution (narrow range ethoxylates, NRE).

In addition to these non-ionic surfactants, fatty alcohols having more than 12 EO can also be used. Examples thereof are (tallow) fatty alcohols having 14 EO, 16 EO, 20 EO, 25 EO, 30 EO or 40 EO. In agents for use in machine methods in particular, extremely low-foaming compounds are conventionally used. These preferably include C₁₂-C₁₈ alkyl polyethylene glycol polypropylene glycol ethers having up to 8 mol of ethylene oxide and propylene oxide units in the molecule. However, other known, low-foaming, non-ionic surfactants can also be used such as C₁₂-C₁₈ alkyl polyethylene glycol polybutylene glycol ethers having up to 8 mol of ethylene oxide and butylene oxide units in the molecule, as well as end-capped alkyl polyalkylene glycol mixed ethers. Hydroxyl-group-containing alkoxylated alcohols as described in European Patent Application EP 0 300 305, known as hydroxy mixed ethers, are also particularly preferred. The non-ionic surfactants also include alkyl glycosides of the general formula RO(G)ₓ, in which R is a primary straight-chain or methyl-branched aliphatic residue, particularly one methyl-branched in the 2-position, having 8 to 22, preferably 12 to 18 C atoms, and G is a glycose unit having 5 or 6 C atoms, preferably glucose. The degree of oligomerization x, which indicates the distribution of monoglycosides and oligoglycosides, is any number—which as a quantity determined by analysis can also assume fractional values—between 1 and 10; x is preferably 1.2 to 1.4. Likewise suitable are polyhydroxy fatty acid amides of the formula (I), in which R¹CO is an aliphatic acyl residue having 6 to 22 carbon atoms, R² is hydrogen, an alkyl or hydroxyalkyl residue having 1 to 4 carbon atoms, and [Z] is a linear or branched polyhydroxyalkyl residue having 3 to 10 carbon atoms and 3 to 10 hydroxyl groups:

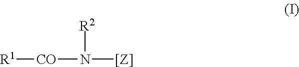

Polyhydroxy fatty acid amides preferably derive from reducing sugars having 5 or 6 carbon atoms, in particular from glucose. Polyhydroxy fatty acid amides also include compounds of the formula (II)—

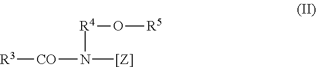

wherein R³ is a linear or branched alkyl or alkenyl residue having 7 to 12 carbon atoms; R⁴ is a linear, branched or cyclic alkylene residue or an arylene residue having 2 to 8 carbon atoms; R⁵ is a linear, branched or cyclic alkyl residue or an aryl residue or an oxyalkyl residue having 1 to 8 carbon atoms with C₁-C₄ alkyl or phenyl residues being preferred; and [Z] is a linear polyhydroxyalkyl residue whose alkyl chain is substituted with at least two hydroxyl groups, or alkoxylated, preferably ethoxylated or propoxylated derivatives of this residue. [Z] is preferably obtained by reductive amination of a sugar such as glucose, fructose, maltose, lactose, galactose, mannose or xylose. The N-alkoxy- or N-aryloxy-substituted compounds can then be converted into the desired polyhydroxy fatty acid amides, for example, by reaction with fatty acid methyl esters in the presence of an alkoxide as catalyst.

Another class of non-ionic surfactants that are preferably used either as the only non-ionic surfactant or in combination with other non-ionic surfactants, particularly together with alkoxylated fatty alcohols and/or alkyl glycosides, are alkoxylated, preferably ethoxylated or ethoxylated and propoxylated, fatty acid alkyl esters, preferably having 1 to 4 carbon atoms in the alkyl chain, in particular fatty acid methyl esters. Non-ionic surfactants of the amine oxide type, for example, N-cocoalkyl-N,N-dimethyl amine oxide and N-tallow alkyl-N,N-dihydroxyethyl amine oxide, and of the fatty acid alkanol amide type can also be suitable. The amount of these non-ionic surfactants is preferably no more than that of the ethoxylated fatty alcohols, in particular no more than half that.

So-called gemini surfactants are also suitable as additional surfactants. This term refers in general to compounds having two hydrophilic groups per molecule. As a rule these groups are separated from one another by means of a “spacer”. This spacer is normally a carbon chain, which should be long enough for the hydrophilic groups to be far enough apart that they can act independently of one another. Such surfactants generally have the characteristic feature of having an unusually low critical micelle concentration and the ability to greatly reduce the surface tension of water. In exceptional cases the term gemini surfactants refers not only to such “dimeric” surfactants, but also correspondingly to “trimeric” surfactants. Suitable gemini surfactants include sulfated hydroxy mixed ethers or dimeric alcohol bis- and trimeric alcohol tris-sulfates and ether sulfates. End-capped dimeric and trimeric mixed ethers have the characteristic feature in particular of being bifunctional and polyfunctional. Thus the cited end-capped surfactants have good wetting characteristics and are low-foaming, making them particularly suitable for use in machine washing or cleaning methods. Gemini polyhydroxy fatty acid amides or poly-polyhydroxy fatty acid amides can also be used, however.

Sulfuric acid monoesters of the straight-chain or branched C₇-C₂₁ alcohols ethoxylated with 1 to 6 mol of ethylene oxide, such as 2-methyl-branched C₉-C₁₁ alcohols having on average 3.5 mol of ethylene oxide (EO) or C₁₂-C₁₈ fatty alcohols having 1 to 4 EO, are also suitable. The preferred anionic surfactants also include salts of alkyl sulfosuccinic acid, which are also known as sulfosuccinates or sulfosuccinic acid esters, as well as monoesters and/or diesters of sulfosuccinic acid with alcohols, preferably fatty alcohols and in particular ethoxylated fatty alcohols. Preferred sulfosuccinates contain C₈ to C₁₈ fatty alcohol residues or mixtures thereof. Particularly preferred sulfosuccinates contain a fatty alcohol residue derived from ethoxylated fatty alcohols which are non-ionic surfactants in their own right. Once again, sulfosuccinates whose fatty alcohol residues derive from ethoxylated fatty alcohols having a narrow homolog distribution are particularly preferred. It is likewise possible to use alk(en)yl succinic acid having preferably 8 to 18 carbon atoms in the alk(en)yl chain or salts thereof.

Further possible anionic surfactants include fatty acid derivatives of amino acids, for example of N-methyltaurine (taurides) and/or of N-methylglycine (sarcosides). Sarcosides or sarcosinates are preferred in particular, and above all sarcosinates of higher and optionally mono- or polyunsaturated fatty acids such as oleyl sarcosinate.

Other suitable anionic surfactants include soaps. In particular, saturated fatty acid soaps such as the salts of lauric acid, myristic acid, palmitic acid, stearic acid, hydrogenated erucic acid and docosanoic acid are suitable, and in particular soap mixtures derived from natural fatty acids, (e.g., coconut, palm kernel or tallow fatty acids). Known alkenyl succinic acid salts can also be used together with these soaps or as a substitute for soaps.

Anionic surfactants including the soaps can be present in the form of their sodium, potassium or ammonium salts and as soluble salts of organic bases such as mono-, di- or triethanolamine. The anionic surfactants are preferably in the form of their sodium or potassium salts, particularly in the form of their sodium salts.

Surfactants are included in the washing agents according to the invention in proportions of preferably 5 wt. % to 50 wt. %, in particular 8 wt. % to 30 wt. %.

Agents according to the invention preferably contain at least one water-soluble and/or water-insoluble, organic and/or inorganic builder. Water-soluble organic builder substances include polycarboxylic acids, particularly citric acid and sugar acids, monomeric and polymeric aminopolycarboxylic acids, in particular methylglycine diacetic acid, nitrilotriacetic acid and ethylenediamine tetraacetic acid, as well as polyaspartic acid, polyphosphonic acids, in particular amino tris(methylene phosphonic acid), ethylenediamine tetrakis(methylene phosphonic acid) and 1-hydroxyethane-1,1-diphosphonic acid, polymeric hydroxy compounds such as dextrin as well as polymeric (poly)carboxylic acids, in particular the polycarboxylates obtainable by oxidation of polysaccharides or dextrins, polymeric acrylic acids, methacrylic acids, maleic acids and mixed polymers thereof, which can also contain small amounts of polymerizable substances without carboxylic acid functionality incorporated by polymerization. The relative molecular mass of homopolymers of unsaturated carboxylic acids is generally from 3000 to 200,000, for copolymers from 2000 to 200,000, preferably 30,000 to 120,000, relative to free acid. A particularly preferred acrylic acid-maleic acid copolymer has a relative molecular mass of 30,000 to 100,000. Commercial products include Sokalan® CP 5, CP 10 and PA 30 from BASF. Suitable yet less preferred compounds of this class include copolymers of acrylic acid or methacrylic acid with vinyl ethers, such as vinyl methyl ethers, vinyl esters, ethylene, propylene and styrene, in which the proportion of acid is at least 50 wt. %. Terpolymers containing two unsaturated acids and/or the salts thereof as monomers along with vinyl alcohol and/or an esterified vinyl alcohol or a carbohydrate as the third monomer can also be used as water-soluble builder substances. The first acid monomer or salt thereof is derived from a monoethylenically unsaturated C₃-C₈ carboxylic acid and preferably from a C₃-C₄ monocarboxylic acid, in particular from (meth)acrylic acid. The second acid monomer or salt thereof can be a derivative of a C₄-C₈ dicarboxylic acid, maleic acid being particularly preferred, and/or a derivative of an allyl sulfonic acid, which is substituted in the 2-position with an alkyl or aryl residue. Such polymers generally have a relative molecular mass of from 1000 to 200,000. Further preferred copolymers are those preferably having acrolein and acrylic acid/acrylic acid salts or vinyl acetate as monomers. For the production of liquid agents in particular, the organic builder substances can be used in the form of aqueous solutions, preferably in the form of 30 to 50 wt. % aqueous solutions. All the cited acids are generally used in the form of their water-soluble salts, in particular their alkali salts.

Such organic builder substances can be included if desired in amounts of up to 40 wt. %, in particular up to 25 wt. % and preferably from 1 wt. % to 8 wt. %. Amounts close to the cited upper limit are preferably used in paste-form or liquid, in particular water-containing, agents according to the invention.

Suitable water-soluble, inorganic builder materials are in particular alkali silicates, alkali carbonates and alkali phosphates, which can be present in the form of their alkaline, neutral or acid sodium or potassium salts. Examples thereof are trisodium phosphate, tetrasodium diphosphate, disodium dihydrogen diphosphate, pentasodium triphosphate, so-called sodium hexametaphosphate, oligomeric trisodium phosphate with degrees of oligomerization of 5 to 1000, in particular 5 to 50, as well as the corresponding potassium salts or mixtures of sodium and potassium salts. Crystalline or amorphous alkali aluminosilicates in particular are used as water-insoluble, water-dispersible inorganic builder materials, in amounts of up to 50 wt. %, preferably not over 40 wt. % and in liquid agents in particular in amounts of 1 wt. % to 5 wt. %. Of these, the crystalline sodium aluminosilicates in washing agent quality are preferred, in particular zeolite A, P and optionally X, alone or in mixtures, for example, in the form of a co-crystallisate of zeolites A and X (Vegobond® AX, a commercial product from Condea Augusta S.p.A.). Amounts close to the cited upper limit are preferably used in solid, particulate agents. Suitable aluminosilicates have in particular no particles with a particle size of more than 30 μm and preferably consist of at least 80 wt. % of particles with a size of less than 10 μm. Their calcium-binding capacity, which can be determined by the method described in German patent DE 24 12 837, is generally in the range from 100 to 200 mg CaO per gram.

Suitable substitutes or partial substitutes for the cited aluminosilicates are crystalline alkali silicates, which can be present alone or mixed with amorphous silicates. Alkali silicates that can be used as builders in agents according to the invention preferably have a molar ratio of alkali oxide to SiO₂ of less than 0.95, in particular from 1:1.1 to 1:12, and can be amorphous or crystalline. Preferred alkali silicates include the sodium silicates, particularly amorphous sodium silicates with a molar ratio of Na₂O:SiO₂ of 1:2 to 1:2.8. Crystalline layered silicates of the general formula Na₂SiₓO₂ₓ₊₁.yH₂O are preferably used as crystalline silicates, which can be present alone or mixed with amorphous silicates, wherein the modulus x is a number from 1.9 to 22, in particular 1.9 to 4, and y is a number from 0 to 33, with preferred values for x being 2, 3 or 4. Preferred crystalline layered silicates are those in which x assumes the values 2 or 3 in the cited general formula. In particular both β- and δ-sodium disilicates (Na₂Si₂O₅.yH₂O) are preferred. Virtually anhydrous crystalline alkali silicates of the aforementioned general formula prepared from amorphous alkali silicates, in which x denotes a number from 1.9 to 2.1, can also be used in agents according to the invention. In a further preferred embodiment of agents according to the invention a crystalline sodium layered silicate with a modulus of 2 to 3 is used, such as can be prepared from sand and soda. Crystalline sodium silicates with a modulus in the range from 1.9 to 3.5 are used in a further preferred embodiment of agents according to the invention. Crystalline layered silicates of the aforementioned formula (I) are sold by the company Clariant GmbH under the trade name Na-SKS, for example Na-SKS-1 (Na₂Si₂₂O₄₅.xH₂O, kenyaite), Na-SKS-2 (Na₂Si₁₄O₂₉.xH₂O, magadiite), Na-SKS-3 (Na₂Si₈O₁₇.xH₂O) or Na-SKS-4 (Na₂Si₄O₉.xH₂O, makatite). Of these, Na-SKS-5 (α-Na₂Si₂O₅), Na-SKS-7 (β-Na₂Si₂O₅, natrosilite), Na-SKS-9 (NaHSi₂O₅.3H₂O), Na-SKS-10 (NaHSi₂O₅.3H₂O, kanemite), Na-SKS-11 (t-Na₂Si₂O₅) and Na-SKS-13 (NaHSi₂O₆) are suitable above all, but in particular Na-SKS-6 (δ-Na₂Si₂O₅). In a preferred embodiment of agents according to the invention, a granular compound consisting of crystalline layered silicate and citrate, crystalline layered silicate and the aforementioned (co)polymeric polycarboxylic acid, or alkali silicate and alkali carbonate is used, such as is available commercially under the name Nabion® 15, for example.

Builder substances are preferably contained in agents according to the invention in amounts of up to 75 wt. %, in particular 5 wt. % to 50.

Useful peroxygen compounds in agents according to the invention include organic peracids or peracid salts of organic acids such as phthalimidoperhexanoic acid, perbenzoic acid or salts of diperdodecanedioic acid, hydrogen peroxide and inorganic salts which give off hydrogen peroxide under washing conditions, including perborate, percarbonate, persilicate and/or persulfate such as caroate. If solid peroxygen compounds are to be used, they can be used in the form of powders or granules, which can also be coated in a manner known in principle. If an agent according to the invention contains peroxygen compounds, these are present in amounts of preferably up to 50 wt. %, in particular from 5 wt. % to 30 wt. %. The addition of small amounts of known bleaching agent stabilizers such as phosphonates, borates or metaborates and metasilicates as well as magnesium salts such as magnesium sulfate can be useful.

Compounds which under perhydrolysis conditions yield aliphatic peroxocarboxylic acids having preferably 1 to 10 C atoms, particularly 2 to 4 C atoms, and/or optionally substituted perbenzoic acid can be used as bleach activators. Substances carrying 0 and/or N acyl groups of the cited C atomic number and/or optionally substituted benzoyl groups are suitable. Polyacylated alkylene diamines, in particular tetraacetyl ethylenediamine (TAED), acylated triazine derivatives, in particular 1,5-diacetyl-2,4-dioxohexahydro-1,3,5-triazine (DADHT), acylated glycolurils, in particular tetraacetyl glycoluril (TAGU), N-acylimides, in particular N-nonanoyl succinimide (NOSI), acylated phenol sulfonates, in particular n-nonanoyl or isononanoyl oxybenzene sulfonate (n- or iso-NOBS), carboxylic anhydrides, in particular phthalic anhydride, acylated polyhydric alcohols, in particular triacetin, ethylene glycol diacetate, 2,5-diacetoxy-2,5-dihydrofuran and enol esters, as well as acetylated sorbitol and mannitol or mixtures thereof (SORMAN) that have been described, acylated sugar derivatives, in particular pentaacetyl glucose (PAG), pentaacetyl fructose, tetraacetyl xylose and octaacetyl lactose, as well as acetylated, optionally N-alkylated glucamine and gluconolactone, and/or N-acylated lactams, for example, N-benzoyl caprolactam, are preferred. The hydrophilically substituted acyl acetals and acyl lactams are likewise preferably used. Combinations of conventional bleach activators can also be used. Such bleach activators, particularly if aforementioned hydrogen-peroxide-yielding bleaching agents are present, can be included preferably in amounts of 0.5 wt. % to 10 wt. %, in particular 1 wt. % to 8 wt. %, relative to the complete agent, but if percarboxylic acid is used as the sole bleaching agent they are preferably omitted altogether.

Sulfonimines and/or bleach-reinforcing transition metal salts or transition metal complexes can also be included as so-called bleach catalysts in addition to the conventional bleach activators or in their place.

Suitable enzymes for use in the agents include those from the class of amylases, proteases, lipases, cutinases, pullulanases, hemicellulases, cellulases, oxidases, laccases and peroxidases as well as mixtures thereof. Enzymatic active ingredients obtained from fungi or bacteria, such as Bacillus subtilis, Bacillus licheniformis, Bacillus lentus, Streptomyces griseus, Humicola lanuginosa, Humicola insolens, Pseudomonas pseudoalcaligenes, Pseudomonas cepacia or Coprinus cinereus are particularly suitable. The enzymes can be adsorbed onto supporting materials and/or embedded in coating substances to protect them against premature inactivation. They are preferably contained in washing or cleaning agents according to the invention in amounts of up to 5 wt. %, in particular 0.2 wt. % to 4 wt. %. If the agent according to the invention contains protease, it preferably has a proteolytic activity in the range from around 100 PE/g to around 10,000 PE/g, in particular 300 PE/g to 8000 PE/g. If several enzymes are to be used in the agent according to the invention, this can be achieved by incorporating the two or more separate enzymes or enzymes formulated separately in a known manner or two or more enzymes formulated together in granules.

Organic solvents that can be used in addition to water in agents according to the invention, particularly if those in liquid or paste form, include alcohols having 1 to 4 C atoms such as methanol, ethanol, isopropanol and tert-butanol, diols having 2 to 4 C atoms such as ethylene glycol and propylene glycol, and mixtures thereof and ethers derivable from the cited classes of compounds. Such water-miscible solvents are preferably present in agents according to the invention in amounts not exceeding 30 wt. %, in particular 6 wt. % to 20 wt. %.

To set a desired pH that is not established automatically by mixing the other components, agents according to the invention can contain system-compatible and environmentally compatible acids such as citric acid, acetic acid, tartaric acid, malic acid, lactic acid, glycolic acid, succinic acid, glutaric acid and/or adipic acid, as well as mineral acids such as sulfuric acid or bases such as ammonium or alkali hydroxides. Such pH regulators are included in agents according to the invention in amounts preferably not exceeding 20 wt. %, particularly 1.2 wt. % to 17 wt. %.

Graying inhibitors have the task of suspending dirt released from the textile fibers in the liquor. Water-soluble colloids, mostly of an organic nature, are suitable for this purpose, for example, starch, glue, gelatin, salts of ether carboxylic acids or ether sulfonic acids of starch or cellulose or salts of acid sulfuric acid esters of cellulose or starch. Water-soluble polyamides containing acid groups are also suitable for this purpose. Starch derivatives other than those mentioned above can also be used, for example, aldehyde starches. Cellulose ethers such as carboxymethyl cellulose (Na salt), methyl cellulose, hydroxyalkyl cellulose and mixed ethers, such as methylhydroxyethyl cellulose, methylhydroxypropyl cellulose, methylcarboxymethyl cellulose and mixtures thereof are preferably used, for example, in amounts of 0.1 to 5 wt. %, relative to the agents.

Textile washing agents according to the invention can include derivatives of diaminostilbene disulfonic acid or alkali metal salts thereof as optical brighteners, although for use as color washing agents they are preferably free from optical brighteners. Salts of 4,4′-bis(2-anilino-4-morpholino-1,3,5-triazinyl-6-amino)stilbene-2,2′-disulfonic acid or similarly structured compounds bearing a diethanolamino group, a methylamino group, an anilino group or a 2-methoxyethylamino group in place of the morpholino group, are suitable for example. Brighteners of the substituted diphenyl styryl type can also be present, for example, alkali salts of 4,4′-bis(2-sulfostyryl)diphenyl, 4,4′-bis(4-chloro-3-sulfostyryl)diphenyl, or 4-(4-chlorostyryl)-4′-(2-sulfostyryl)diphenyl. Mixtures of the aforementioned optical brighteners can also be used.

When used in machine methods it can be advantageous to add conventional foam inhibitors to the agents. Soaps of natural or synthetic origin such as those having a high proportion of C₁₈ to C₂₄ fatty acids are suitable as foam inhibitors. Suitable non-surfactant foam inhibitors include organopolysiloxanes and mixtures thereof with microtine, optionally silanized silicic acid and paraffins, waxes, microcrystalline waxes and mixtures thereof with silanized silicic acid or bis-fatty acid alkylene diamides. Mixtures of various foam inhibitors such as those comprising silicones, paraffins or waxes are also used to advantage. Foam inhibitors, particularly silicone- and/or paraffin-containing foam inhibitors, are preferably bound to a granular, water-soluble or water-dispersible carrier substance. Mixtures of paraffins and bistearyl ethylenediamide are preferred.

The production of solid agents according to the invention can occur by known methods such as spray drying or granulation, wherein enzymes and possible other thermally sensitive ingredients such as bleaching agents can optionally be added separately at a later stage. A method involving an extrusion step is preferred for production of agents according to the invention having an elevated bulk density, particularly in the range from 650 g/l to 950 g/l.

To produce agents according to the invention in tablet form (which can comprise one or more phases, one or more colors and in particular can consist of one or more layers, in particular two layers), the procedure followed is preferably to mix all constituents—optionally for each layer—together in a mixer and then to press the mixture by means of conventional tablet presses such as eccentric presses or rotary presses using pressing forces in a range from around 50 to 100 kN, preferably 60 to 70 kN. For multilayer tablets it can be advantageous to prepress at least one layer. This is preferably performed at pressing forces of between 5 and 20 kN, in particular at 10 to 15 kN. Break-resistant tablets which nevertheless dissolve adequately quickly under usage conditions and which have breaking strengths and bending strengths of normally 100 to 200 N, but preferably over 150 N, are obtained in this way without problem. A tablet produced in this way preferably has a weight of 10 g to 50 g, in particular 15 g to 40 g. The tablets can be of any shape and can be round, oval or polygonal, but intermediate shapes are also possible. Corners and edges are advantageously rounded. Round tablets preferably have a diameter of 30 mm to 40 mm. The size of polygonal or cuboid tablets in particular, which are mostly introduced into the dishwasher for example via the dispensing device, depends on the geometry and the volume of this dispensing device. Preferred embodiments by way of example have a base area of (20 to 30 mm)×(34 to 40 mm), in particular 26×36 or 24×38 mm.

Liquid or paste agents according to the invention in the form of solutions containing conventional solvents, in particular water, are generally produced by simply mixing the ingredients, which can be introduced into an automatic mixer in bulk or as a solution.

### EXAMPLE

A particulate polyamide was added to a standard washing agent.

Result: In comparison to the washing agent without the particles according to the invention, the white textiles washed together with colored textiles were less stained when the washing agent containing the polymer particles was used; the washed-out color was trapped by the polymer particles, as demonstrated by the fact that the particles were stained.

We claim:

1. Washing, prewashing, postwashing or cleaning agent comprising:
a particulate water-insoluble polymeric color-transfer inhibitor, and
conventional ingredients compatible with the inhibitor.

2. Agent according to claim 1, wherein the particulate polymer is present in an amount of 0.05 wt. % to 20 wt. %, based on total weight of the agent.

3. Agent according to claim 1, wherein the particulate polymer is applied to a water-insoluble cloth.

4. Agent according to claim 1 further comprising a polymer chosen from vinyl pyrrolidone, vinyl imidazole, vinyl pyridine-N-oxide or a copolymer thereof.

5. Method for preventing transfer of textile dyes from dyed textiles to undyed or differently colored textiles when washed together comprising washing dyed textiles in surfactant-containing aqueous solutions comprising a particulate polymer.

6. Agent according to claim 1, wherein the particulate polymer is chosen from polyamide, polyester, polyimide, aramide, polyacrylonitrile, polyurethane, polypropylene, polyvinyl chloride, cellulose and copolymers of at least two of the monomers forming these polymers.

7. Agent according to claim 1, wherein the polymer particles have particle sizes in a range of from 1 nm to 500 μm.

8. Agent according to claim 1, wherein the average particle size of the polymer particles is in a range of from 5 nm to 100 μm.
